(19) United States
(12) Patent Application Publication
(10) Pub. No.: US 2025/0293237 A1
(43) Pub. Date: Sep. 18, 2025

(54) LITHIUM SECONDARY BATTERY AND SECONDARY BATTERY MODULE INCLUDING THE SAME

(71) Applicant: SK On Co., Ltd., Seoul (KR)

(72) Inventors: Jun Hee HAN, Daejeon (KR); Hyo Mi KIM, Daejeon (KR); Da Bin CHUNG, Daejeon (KR); Seong Cho KWON, Daejeon (KR); Moon Sung KIM, Daejeon (KR); Sang Baek RYU, Daejeon (KR); Da Hye PARK, Daejeon (KR); Sang Won PARK, Daejeon (KR); Sang In BANG, Daejeon (KR); Seung Hyun YOOK, Daejeon (KR); Hwan Ho JANG, Daejeon (KR)

(21) Appl. No.: 18/977,958

(22) Filed: Dec. 12, 2024

(30) Foreign Application Priority Data
Mar. 15, 2024 (KR) 10-2024-0036514

(51) Int. Cl. H01M 4/36; H01M 4/02; H01M 4/38; H01M 4/583; H01M 10/052

(52) U.S. Cl. CPC H01M 4/364; H01M 4/386; H01M 4/583; H01M 10/052; H01M 2004/027

(57) ABSTRACT

A lithium secondary battery according to an embodiment includes an electrode assembly 1 in which a first electrode group 2 including at least one first unit cell 10; and a second electrode group 4 including at least one second unit cell 30 are alternately assembled. The first unit cell 10 includes a first-first anode mixture layer 111a on the first anode current collector 110; and a first-second anode mixture layer 111b on the first-first anode mixture layer. The second unit cell 30 includes a second-first anode mixture layer 311a on the second anode current collector 310; and a second-second anode mixture layer 311b on the second-first anode mixture layer. The first-first anode mixture layer 111a includes a carbon-based active material, and each of the first-second anode mixture layer 111b, the second-first anode mixture layer 311a and the second-second anode mixture layer 311b includes a silicon-based active material.

### CROSS-REFERENCE TO RELATED APPLICATION(S)

This patent document claims the priority and benefits of Korean Patent Application No. 10-2024-0036514 filed on Mar. 15, 2024, the disclosure of which is incorporated herein by reference in its entirety.

### TECHNICAL FIELD

The disclosure and implementations disclosed in this patent document generally relates to a lithium secondary battery and a secondary battery module including the same.

### BACKGROUND

Recently, with an increase in interest in environmental issues, much research has been conducted on electric vehicles (EV) and hybrid electric vehicles (HEV) that may replace vehicles using fossil fuels, such as gasoline vehicles and diesel vehicles, which are one of the main causes of air pollution. Lithium secondary batteries with high discharge voltage and output stability are mainly used as power sources for such electric vehicles (EV) and hybrid electric vehicles (HEV). In addition, as the need for high-energy secondary batteries with high energy density increases, development and research on high-capacity cathodes for this have also been actively conducted.

### SUMMARY

An aspect of the present disclosure is to provide a lithium secondary battery having excellent energy density.

Another aspect of the present disclosure is to provide a lithium secondary battery having excellent lifespan performance.

Another aspect of the present disclosure is to provide a lithium secondary battery having excellent rapid charging performance.

Another aspect of the present disclosure is to provide a lithium secondary battery having excellent output performance.

A lithium secondary battery according to an example of the present disclosure includes: an electrode assembly in which a first electrode group including one or more first unit cells, and a second electrode group including one or more second unit cells are alternately assembled. The first unit cell: includes a first anode current collector, and a first anode including a first anode mixture layer on the first anode current collector, the first anode mixture layer includes a first-first anode mixture layer on the first anode current collector, and a first-second anode mixture layer on the first-first anode mixture layer. The second unit cell includes: a second anode current collector; and a second anode including a second anode mixture layer on the second anode current collector, and the second anode mixture layer includes a second-first anode mixture layer on the second anode current collector, and a second-second anode mixture layer on the second-first anode mixture layer.

The first-first anode mixture layer includes a carbon-based active material, each of the first-second anode mixture layer, the second-first anode mixture layer and the second-second anode mixture layer includes a silicon-based active material, an amount of the silicon-based active material included in the first-second anode mixture layer is 7 to 23 wt % based on a total weight of the first-second anode mixture layer, and a weight of the silicon-based active material included in the second-second anode mixture layer is greater than or equal to a weight of the silicon-based active material included in the second-first anode mixture layer.

In some embodiments, the first-first anode mixture layer may include a combination of artificial graphite and natural graphite as a carbon-based active material.

In some embodiments, a weight of the artificial graphite included in the first-first anode mixture layer may be greater than or equal to the weight of the natural graphite.

In some embodiments, the first-first anode mixture layer may not include the silicon-based active material.

In some embodiments, each of the first-second anode mixture layer, the second-first anode mixture layer and the second-second anode mixture layer may further include a carbon-based active material. A weight of the carbon-based active material included in the first-first anode mixture layer may be greater than or equal to weights of each carbon-based active material included in the first-second anode mixture layer, the second-first anode mixture layer and the second-second anode mixture layer.

In some embodiments, the silicon-based active material may be at least one selected from the group consisting of Si, SiOx (0<x<2), a Si-Q alloy (where Q is an element selected from the group consisting of an alkali metal, an alkaline earth metal, a Group 13 element, a Group 14 element, a Group 15 element, a Group 16 element, a transition metal, a rare earth element, and combinations thereof, but is not Si), and a Si—C composite.

In some embodiments, the first-second anode mixture layer may include a first-second silicon-based active material as a silicon-based active material, the second-first anode mixture layer may include a second-first silicon-based active material as a silicon-based active material, and the second-second anode mixture layer may include a second-second silicon-based active material as a silicon-based active material. At least two kinds of the first-second silicon-based active material, the second-first silicon-based active material and the second-second silicon-based active material are different from each other.

In some embodiments, the first-second silicon-based active material, the second-first silicon-based active material and the second-second silicon-based active material may all be different from each other.

In some embodiments, the first-second silicon-based active material may be a Si—C composite, and the second-first silicon-based active material may be SiOx (0<x<2), and the second-second silicon-based active material is metal-doped SiOx (0<x<2).

In some embodiments, a content of the silicon-based active material in the first anode mixture layer may be 0.1 to 30 wt % based on a total weight of the first anode mixture layer, and a content of the silicon-based active material in the second anode mixture layer may be 0.1 to 30 wt % based on a total weight of the second anode mixture layer.

In some embodiments, a content of the silicon-based active material included in the second-first anode mixture layer may be 1 to 8 wt % based on a total weight of the second-first anode mixture layer, and a content of the silicon-based active material included in the second-second anode mixture layer may be 8 to 15 wt % based on a total weight of the second-second anode mixture layer.

In some embodiments, each of the first-second anode mixture layer, the second-first anode mixture layer and the second-second anode mixture layer may further include a conductive material.

In some embodiments, the electrode assembly may satisfy the condition of the following Equation 1.

$$0.1 < A 1 / A 2 < 3.0 \qquad [ Equation 1 ]$$

In Equation 1, A1 is a total number of the first unit cells, and A2 is a total number of the second unit cells.

In some embodiments, the electrode assembly may satisfy the condition of the following Equation 2,

$$0.1 < B 1 / B 2 < 3.0 \qquad [ Equation 2 ]$$

In Equation 2, B1 is a total number of the first electrode group, and B2 is a total number of the second electrode group.

A secondary battery module according to an embodiment includes a lithium secondary battery according to one of the above-described embodiments.

According to an embodiment of the present disclosure, the energy density of a lithium secondary battery may be improved.

According to another embodiment of the present disclosure, lifespan performance of a lithium secondary battery may be improved.

According to another embodiment of the present disclosure, rapid charging performance of a lithium secondary battery may be improved.

According to another embodiment of the present disclosure, output power performance of a lithium secondary battery may be improved.

### BRIEF DESCRIPTION OF DRAWINGS

Certain aspects, features, and advantages of the present disclosure are illustrated by the following detailed description with reference to the accompanying drawings.

FIG. 1 is a perspective view conceptually illustrating an assembly structure of a first unit cell and a second unit cell according to an embodiment.

FIG. 2A is a cross-sectional view illustrating a structure of a first anode according to an embodiment.

FIG. 2B is a cross-sectional view illustrating a structure of a second anode according to an embodiment.

FIGS. 3A and 4A are plan views respectively illustrating a shape in which an assembly structure of a first electrode group and a second electrode group according to embodiments is observed from an upper surface.

FIGS. 3B and 4B are front views respectively illustrating a form in which an assembly structure of a first electrode group and a second electrode group according to embodiments is observed based on a surface from which an anode non-coated portion protrudes.

FIGS. 3C and 4C are views respectively illustrating a form in which an assembly structure of a first electrode group and a second electrode group in an electrode assembly according to embodiments is observed from a side surface.

FIGS. 3D and 4D are plan views respectively illustrating a form in which a connection structure between electrode tabs and electrode leads of each electrode group in an electrode assembly according to embodiments is observed from an upper surface.

FIGS. 3E and 4E are views respectively illustrating a form in which a connection structure between electrode tabs and electrode leads of each electrode group in an electrode assembly according to embodiments is observed from a side surface.

### DETAILED DESCRIPTION

In order to implement a secondary battery having high capacity and high energy density, an anode for a lithium secondary battery according to an embodiment may include a silicon-based active material having a high discharge capacity as compared to graphite. However, the silicon-based active material may have a large volumetric expansion rate as compared to graphite, and may cause relatively large shrinkage/expansion during repeated charge/discharge processes of a battery, which may cause peeling of an electrode mixture layer, an increase in internal resistance of an electrode, a side reaction with an electrolyte, and a decrease in lifespan characteristics of the electrode. Meanwhile, for rapid charging of a lithium secondary battery, a stable high-rate charging characteristic of a secondary battery may be required.

According to an embodiment of the present disclosure, a lithium secondary battery having high energy density and excellent lifespan performance and rapid charging performance may be provided. Hereinafter, embodiments of the present disclosure will be described in detail, but the scope thereof is not limited to the embodiments described below. In addition, embodiments of the present disclosure may be applied by being limited to embodiments to be described below, and may be configured by selectively combining all or some of respective embodiments so that various modifications may be made.

In this specification, when a portion is seen to be connected to another portion, this includes not only cases in which elements are directly connected, but also cases in which the elements are indirectly connected with another element interposed therebetween. Additionally, including an element does not denote excluding other elements unless otherwise specifically stated, but denotes that other elements may be further included.

In this specification, a unit cell is a minimum component unit of a secondary battery including a cathode, an anode, and a separator interposed therebetween, and a first unit cell and a second unit cell described below refer to unit cells having different anode designs, and the like.

In this specification, an electrode group is a component unit including one or more of the unit cells, and the first electrode group and the second electrode group described below denote groups of electrodes respectively including a structure in which the first unit cell and the second unit cell are assembled.

In this specification, the electrode assembly is a component unit including at least one of the first electrode group and the second electrode group, and denotes a component including a structure in which the first electrode group and the second electrode group are assembled.

In this specification, a non-coated portion denotes a portion of an anode or cathode current collector on which an electrode mixture layer is not coated on a surface, and denotes a portion disposed on at least one surface of the current collector.

### Lithium Secondary Battery

A lithium secondary battery according to an embodiment includes an electrode assembly 1 in which a first electrode group 2 including at least one first unit cell 10; and a second electrode group 4 including at least one second unit cell 30 are alternately assembled.

The first unit cell 10 includes a first anode current collector 110; and a first anode 11 including a first anode mixture layer 111 on the first anode current collector, and the first anode mixture layer 111 includes a first-first anode mixture layer 111a on the first anode current collector; and a first-second anode mixture layer 111b on the first-first anode mixture layer.

The second unit cell 30 includes a second anode 31 including a second anode current collector 310; and a second anode mixture layer 311 on the second anode current collector, and the second anode mixture layer 311 includes a second-first anode mixture layer 311a on the second anode current collector; and a second-second anode mixture layer 311b on the second-first anode mixture layer.

The first-first anode mixture layer 111a includes a carbon-based active material, and each of the first-second anode mixture layer 111b, the second-first anode mixture layer 311a and the second-second anode mixture layer 311b includes a silicon-based active material, and the content of the silicon-based active material included in the first-second anode mixture layer 111b is 7 to 23 wt % based on the total weight of the first-second anode mixture layer 111b, and a weight of the silicon-based active material included in the second-second anode mixture layer 311b is greater than or equal to a weight of the silicon-based active material included in the second-first anode mixture layer 311a.

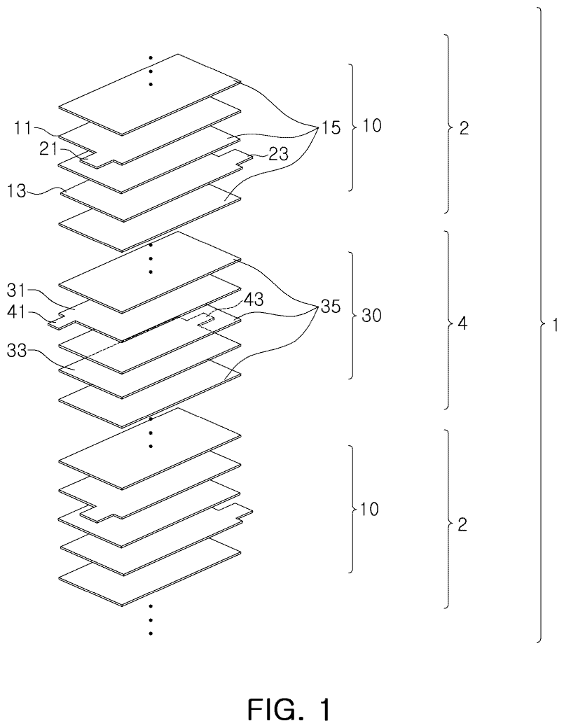

Hereinafter, a structure of the electrode assembly included in the lithium secondary battery will be described in detail with reference to FIG. 1.

### Electrode Assembly Structure

FIG. 1 is a perspective view conceptually illustrating an assembly structure of a first unit cell and a second unit cell according to an embodiment.

Referring to FIG. 1, the lithium secondary battery includes an electrode assembly 1 in which a first electrode group 2 including one or more first unit cells 10 and a second electrode group 4 including one or more second unit cells 30 are alternately assembled.

Each of the first unit cell 10 and the second unit cell 30 may have a bi-cell structure (cathode-separator-anode-separator-cathode) or a mono-cell structure (cathode-separator-anode) in which electrodes having the same polarity are disposed in both ends of a unit cell. However, since the unit cell may have a structure in which a plurality of bi-cells and mono-cells are assembled depending on the design purpose, the structures of the first unit cell and the second unit cell are not limited to the above-described range.

The first unit cell 10 includes a first anode 11, and the second unit cell 30 includes a second anode 31. The first unit cell 10 may further include a first cathode 13 and a first separator 15, and the second unit cell 30 may further include a second cathode 33 and a second separator 35.

Each of the first electrode group 2 and the second electrode group 4 may include anodes having different active material contents and different layer structures, and thus may have different electrochemical performances. Accordingly, the electrode assembly including the first electrode group and the second electrode group may secure excellent levels of energy density, lifespan characteristics, output characteristics, and rapid charging characteristics.

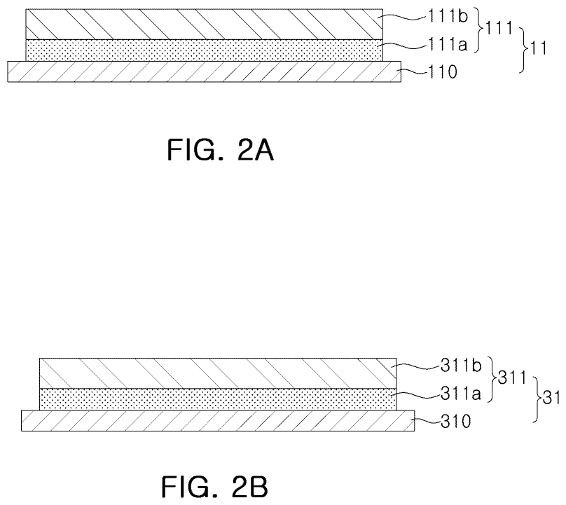

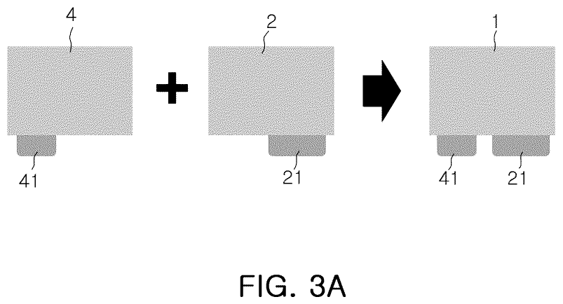

Hereinafter, the first anode 11 and the second anode 31 included in the first electrode group 2 and the second electrode group 4 are described in detail with reference to FIGS. 2A and 2B.

### Anode Design

FIG. 2A is a cross-sectional view illustrating a structure of a first anode according to an embodiment.

FIG. 2B is a cross-sectional view illustrating a structure of a second anode according to an embodiment

Each of the first anode 11 and the second anode 31 has a multilayer structure including two or more electrode mixture layers, and the first anode includes a first anode current collector 110; and a first anode mixture layer 111 on the first cathode current collector, and the first anode mixture layer includes a first-first anode mixture layer 111a on the first anode current collector; and a first-second anode mixture layer 111b on the first-first anode mixture layer.

Additionally, the second anode 31 includes a second anode current collector 310; and a second anode mixture layer 311 on the second anode current collector, and the second anode mixture layer includes a second-first anode mixture layer 311a on the second anode current collector; and a second-second anode mixture layer 311b on the second-first anode mixture layer.

According to an embodiment, a lithium secondary battery having excellent high-rate charging characteristics, energy density, and lifespan characteristics may be provided by including both the first anode and the second anode to which different assembly structures of anode mixture layers having different active material contents are applied.

The components of the first anode current collector 110 and the second anode current collector 310 are not particularly limited. For example, each of the first anode collector 110 and the second anode collector 310 may be a plate or a foil formed of one or more of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and alloys thereof. In some embodiments, each of the first anode collector 110 and the second anode collector 310 may be a copper foil (Cu-foil).

A thickness of the anode collector is not particularly limited. For example, the thickness of the anode collector may be 0.1 μm to 50 μm.

The first-first anode mixture layer 111a includes a carbon-based active material. Hereinafter, a first-first carbon-based active material refers to a carbon-based active material included in the first-first anode mixture layer 111a.

According to an embodiment, in the first anode 11 included in the first electrode group 2, the first-first anode mixture layer 111a as a lower layer includes only a carbon-based active material as an anode active material and may not include a silicon-based active material. Accordingly, since the anode mixture layer adjacent to the first anode current collector 110 does not include the silicon-based active material, the first anode 11 included in the first electrode group 2 may alleviate a phenomenon of electrode detachment due to volumetric expansion/contraction of the silicon-based active material, and may have excellent lifespan characteristics.

The first-first carbon-based active material may be at least one selected from artificial graphite, natural graphite, amorphous hard carbon, low-crystalline soft carbon, carbon black, acetylene black, Ketjen black, super P, graphene, and fibrous carbon. Specifically, the first-first carbon-based active material may include a combination of artificial graphite and natural graphite. That is, according to an embodiment, the first-first anode mixture layer 111a may include a combination of artificial graphite and natural graphite as a carbon-based active material.

Since the natural graphite has lower strength than the artificial graphite, the graphite particles may be easily compressed during electrode rolling. Accordingly, in an anode mixture layer including the combination of the artificial graphite and the natural graphite, a conduction path length between the graphite particles may be reduced. Accordingly, in the first anode mixture layer 111, the first-first anode mixture layer 111a as a lower layer includes a combination of artificial graphite and natural graphite as a carbon-based active material, and the first-second anode mixture layer 111b as an upper layer includes artificial graphite as the carbon-based active material but does not include natural graphite, so that the electrode density of the lower layer may be relatively higher than that of the upper layer. In this case, cell resistance of the first-second anode mixture layer 111b as the upper layer which has a relatively low electrode density, may be reduced, from which high-rate charge/discharge characteristics (rapid charge performance) of the lithium secondary battery may be improved.

When the first-first anode mixture layer 111a includes a combination of artificial graphite and natural graphite as the carbon-based active material, a weight of the artificial graphite included in the first-first anode mixture layer 111a may be greater than or equal to a weight of the natural graphite. Specifically, a weight ratio of the artificial graphite and natural graphite included in the first-first anode mixture layer 111a may be 50:50 to 99:1, or 55:45 to 90:10. More specifically, the weight ratio of the artificial graphite and natural graphite included in the first-first anode mixture layer 111a may be 60:40 to 80:20.

When a content ratio of artificial graphite and natural graphite included in the first-first anode mixture layer 111a is adjusted as described above, the anode mixture layer adjacent to the anode current collector may secure a more excellent level of lifespan characteristics and capacity characteristics of the secondary battery by including artificial graphite having excellent stability and natural graphite having excellent capacity characteristics in an appropriate ratio.

A content of the carbon-based active material, among the anode active materials included in the first-first anode mixture layer 111a, may be 90 to 100 wt %, 95 to 100 wt %, or 99 to 100 wt %. Specifically, the first-first anode mixture layer 111a may include only the carbon-based active material as the anode active material, and a content of the carbon-based active material, among the anode active materials included in the first-first anode mixture layer 111a, may be substantially 100 wt %.

According to an embodiment, the first-first anode mixture layer 111a may include only the carbon-based active material as the anode active material, and may include a small amount of silicon-based active materials to the extent that the silicon-based active materials do not have a substantial effect, or may not include the silicon-based active material at all. Accordingly, the weight ratio of the carbon-based active material and the silicon-based active material included in the first-first anode mixture layer 111a may be 100:0.

In some embodiments, a content of the carbon-based active material in the first-first anode mixture layer 111a may be 95 to 99.9 wt %. Specifically, the content of the carbon-based active material in the first-first anode mixture layer 111a may be 97 to 99.9 wt %.

Each of the first-second anode mixture layer 111b, the second-first anode mixture layer 311a and the second-second anode mixture layer 311b may further include a carbon-based active material. In this case, a weight of the carbon-based active material included in the first-first anode mixture layer 111a may be greater than or equal to weights of each of the carbon-based active materials included in the first-second anode mixture layer 111b, the second-first anode mixture layer 311a and the second-second anode mixture layer 311b.

When each of the first-second anode mixture layer 111b, the second-first anode mixture layer 311a and the second-second anode mixture layer 311b further includes a carbon-based active material, hereinafter, the first-second carbon-based active material, the second-first carbon-based active material and the second-second carbon-based active material refer to carbon-based active materials included in the first-second anode mixture layer 111b, the second-first anode mixture layer 311a, and the second-second anode mixture layer 311b, respectively.

Since each of the first-second anode mixture layer 111b, the second-first anode mixture layer 311a and the second-second anode mixture layer 311b includes the silicon-based active material, even if each of the first-second anode mixture layer 111b, the second-first anode mixture layer 311a and the second-second anode mixture layer 311b further includes the carbon-based active material, a content ratio thereof may be lower than that of the first-first anode mixture layer 111a.

A content of the carbon-based active material included in the first-second anode mixture layer 111b may be 60 to 99.79 wt %. Specifically, the content of the carbon-based active material included in the first-second anode mixture layer 111b may be 67 to 92.89 wt %.

The content of the carbon-based active material included in the second-first anode mixture layer 311a may be 60 to 99.79 wt %. Specifically, the content of the carbon-based active material included in the second-first anode mixture layer 311a may be 82 to 92.89 wt %.

The content of the carbon-based active material included in the second-second anode mixture layer 311b may be 60 to 99.79 wt %. Specifically, the content of the carbon-based active material included in the second-second anode mixture layer 311b may be 75 to 91.89 wt %.

Each of the first-second carbon-based active material, the second-first carbon-based active material and the second-second carbon-based active material may be at least one selected from artificial graphite, natural graphite, amorphous hard carbon, low-crystalline soft carbon, carbon black, acetylene black, ketjen black, super P, graphene, and fibrous carbon, respectively. Specifically, each of the first-second carbon-based active material, the second-first carbon-based active material and the second-second carbon-based active material may be artificial graphite.

Since the natural graphite has relatively low strength as compared to artificial graphite, when used together with the silicon-based active material, the natural graphite may not effectively suppress volumetric expansion of the silicon-based active material due to battery charging/discharging, and as a result, the resistance in the lithium secondary battery may increase, which may deteriorate output characteristics and rapid charging performance of the battery. Accordingly, when the first-second anode mixture layer 111b, the second-first anode mixture layer 311a and the second-second anode mixture layer 311b include artificial graphite together with the silicon-based active material, an occurrence of the above-described problem may be suppressed.

Hereinafter, the silicon-based active materials included in the first-second anode mixture layer 111b, the second-first anode mixture layer 311a and the second-second anode mixture layer 311b will be described in detail.

Each of the first-second anode mixture layer 111b, the second-first anode mixture layer 311a, and the second-second anode mixture layer 311b include the silicon-based active material. Specifically, the first-second anode mixture layer 111b may include a first-second silicon-based active material as a silicon-based active material, the second-first anode mixture layer 311a may include a second-first silicon-based active material as a silicon-based active material, and the second-second anode mixture layer 311b may include a second-second silicon-based active material as a silicon-based active material.

The silicon-based active material may be at least one selected from the group consisting of Si, SiOx (0<x<2), a Si-Q alloy (where Q is an element selected from the group consisting of an alkali metal, an alkaline earth metal, a Group 13 element, a Group 14 element, a Group 15 element, a Group 16 element, a transition metal, a rare earth element, and combinations thereof, but is not Si), and Si—C composites. Specifically, each of the first-second silicon-based active material, the second-first silicon-based active material and the second-second silicon-based active material may be at least one selected from the group.

The silicon-based active material may include at least one silicon-based active material particle selected from the above-described group. In this case, the silicon-based active material may further include a carbon coating layer formed on the silicon-based active material particles. Accordingly, the silicon-based active material particles may be prevented from coming into contact with moisture in the air and/or water in an anode slurry, and may also suppress a decrease in the discharge capacity of the secondary battery.

The carbon coating layer may include at least one selected from the group consisting of amorphous carbon, carbon nanotubes, carbon nanofibers, graphite, graphene, graphene oxide, and reduced graphene oxide.

Additionally, the silicon-based active material may include silicon-based active material particles doped with a metal. In this case, one or more types of alkali metals such as lithium (Li), magnesium (Mg), or alkaline earth metals such as calcium (Ca) may be applied as the metal.

Specifically, the silicon-based active material may include silicon-based active material particles doped with magnesium (Mg). The silicon-based active material doped with the metal may effectively suppress an expansion of the silicon-based active material during charge/discharge by including micropores, and may prevent swelling and cracking of the electrode during charge/discharge, thereby improving the rapid charge lifespan characteristics and the cycle characteristics at room temperature of the lithium secondary battery.

The silicon-based active material may be applied differently for each unit cell or each anode mixture layer depending on the design purpose. Specifically, at least two kinds of the first-second silicon-based active material, the second-first silicon-based active material and the second-second silicon-based active material may be different from each other. According to an embodiment satisfying the configuration, the first-second anode mixture layer 111b may include a Si—C composite as the silicon-based active material, and the second-first anode mixture layer 311a may include SiOx (0<x<2) as the silicon-based active material. That is, the first-second silicon-based active material may be a Si—C composite, and the second-first silicon-based active material may be SiOx (0<x<2).

According to another embodiment, the first-second anode mixture layer 111b may include a Si—C composite as the silicon-based active material, and the second-second anode mixture layer 311b may include a metal-doped SiOx (0<x<2) as the silicon-based active material. That is, the first-second silicon-based active material may be a Si—C composite, and the second-second silicon-based active material may be a metal-doped SiOx (0<x<2).

According to another embodiment, the second-first anode mixture layer 311a may include SiOx (0<x<2) as the silicon-based active material, and the second-second anode mixture layer 311b may include SiOx (0<x<2) doped with a metal as a silicon-based active material. That is, the second-first silicon-based active material may be SiOx (0<x<2), and the second-second silicon-based active material may be SiOx (0<x<2) doped with a metal.

The first-second silicon-based active material, the second-first silicon-based active material, and the second-second silicon-based active material may all be different from each other. Specifically, the first-second anode mixture layer 111b may include a Si—C composite as the silicon-based active material, the second-first anode mixture layer 311a may include SiOx (0<x<2) as the silicon-based active material, and the second-second anode mixture layer 311b may include SiOx (0<x<2) doped with a metal as a silicon-based active material. That is, the first-second silicon-based active material may be a Si—C composite, the second-first silicon-based active material may be SiOx (0<x<2), and the second-second silicon-based active material may be SiOx (0<x<2) doped with a metal.

In a case in which the Si—C composite having high capacity characteristics is applied as the silicon-based active material included in the first-second anode mixture layer 111b as the upper layer, in the first anode 11 having the multilayer structure included in the first electrode group 2, a silicon-based active material may be included in a relatively small content as compared to a general silicon oxide-based (SiOx) active material, so that it may be easy to design a high-capacity anode even when the first-first anode mixture layer 111a as the lower layer does not substantially include the silicon-based active material. Accordingly, a first anode 1 having the reduced content of the silicon-based active material in the entire anode to alleviate problems due to electrode expansion and having improved high-rate charging characteristics, a first unit cell 10 including the same, and a first electrode group 2 may be provided.

In a case of applying SiOx (0<x<2) doped with a metal, specifically, SiOx (0<x<2) doped with magnesium (Mg), as a silicon-based active material included in the second-second anode mixture layer 311b as the upper layer in the second anode 31 of a multilayer structure included in the second electrode group 4, even if a relatively large amount of silicon-based active material is included in the upper layer, an occurrence of a swelling phenomenon, and the like, of the electrode during charge and discharge may be effectively suppressed, and accordingly, it may be easy to design the content of the silicon-based active material of the upper layer to be relatively higher than that of the lower layer. Accordingly, the second anode 31 having excellent capacity characteristics and an improved life maintenance rate, the second unit cell 30 including the same, and the second electrode group 4 may be provided.

A content of the silicon-based active material included in the first anode mixture layer 111 may be 0.1 to 30 wt % based on the total weight of the first anode mixture layer, and a content of the silicon-based active material included in the second anode mixture layer 311 may be 0.1 to 30 wt % based on the total weight of the second anode mixture layer. Specifically, the content of the silicon-based active material included in the first anode mixture layer 111 may be 1 to 15 wt % based on the total weight of the first anode mixture layer, and the content of the silicon-based active material included in the second anode mixture layer 311 may be 1 to 15 wt % based on the total weight of the second anode mixture layer.

In some embodiments, the content of the silicon-based active material in the anode mixture layer may be adjusted differently for each anode as follows.

The content of the silicon-based active material included in the first-second anode mixture layer 111b may be 7 to 23 wt % based on the total weight of the first-second anode mixture layer. Specifically, the content of the silicon-based active material included in the first-second anode mixture layer 111b may be 8 wt % or more or 10 wt % or more, and 20 wt % or less or 15 wt % or less based on the total weight of the first-second anode mixture layer.

The content of the silicon-based active material included in the second-first anode mixture layer 311a may be 1 to 8 wt % based on the total weight of the second-first anode mixture layer.

The content of the silicon-based active material included in the second-second anode mixture layer 311b may be 8 to 15 wt % based on the total weight of the second-second anode mixture layer.

When the silicon-based active material content characteristics of the first-second anode mixture layer 111b are adjusted as described above, the content of the silicon-based active material included in the upper layer (first-second anode mixture layer) in direct contact with the electrolyte may be adjusted in an appropriate range to smoothly induce a movement of lithium ions, and high-rate characteristics may be secured at an excellent level. Accordingly, the first anode 11, the first unit cell 10, and the first electrode group 2 including the first-second anode mixture layer 111b may improve the problem due to volumetric expansion/contraction of the silicon-based active material as well as having excellent rapid charging characteristics.

When the content characteristics of the silicon-based active material in each layer of the second-first anode mixture layer 311a and the second-second anode mixture layer 311b are adjusted as described above, the content of the silicon-based active material included in the lower layer (second-first anode mixture layer) in direct contact with the second anode current collector 310 may be adjusted to be relatively low, thereby alleviating an occurrence of phenomena of appearance distortion and outermost detachment due to volumetric expansion/contraction of the silicon-based active material, and improving a lifespan maintenance rate of the battery, and the content of the silicon-based active material included in the upper layer (second-second anode mixture layer) in direct contact with the electrolyte is adjusted to be relatively high, thereby improving the capacity of an entire anode. Accordingly, the second anode 31 including the anode mixture layers, the second unit cell 30, and the second electrode group 4 may have excellent energy density, lifespan characteristics, and the like.

According to an embodiment, a lithium secondary battery may include an electrode assembly 1 obtained by introducing a structure in which a first electrode group 2 having excellent high-rate charging characteristics and a low volumetric expansion rate; and a second electrode 4 having a relatively excellent lifespan maintenance rate and a relatively excellent energy density are alternately assembled, thereby having excellent lifespan characteristics, excellent energy density, and excellent rapid charging characteristics.

Additionally, even if a specific unit cell is expanded due to an anode relatively greatly affected by the volumetric expansion of the silicon-based active material, a unit cell including an anode that is relatively less affected by this effect is assembled in upper and lower portions, so that a volumetric expansion of the silicon-based active material in the Z-axis (thickness direction) may be uniformly suppressed by the physical pressure.

Meanwhile, in consideration of the silicon-based active material content characteristics for each anode mixture layer, a loading weight (LW) ratio for each layer in the first anode mixture layer 111 and a loading weight (LW) ratio for each layer in the second anode mixture layer 311 may be adjusted. The loading weight (LW) denotes that an amount of an anode mixture layer formed on a current collector, i.e., a layer including an active material, a binder and a conductive material, formed on the current collector, is expressed in units of weight per area.

In this case, the area is based on the area of the current collector, and the weight is based on the weight of the entire formed anode mixture layer.

The loading weight (LW) ratio of the first-first anode mixture layer 111a and the first-second anode mixture layer 111b may be 1:3 to 3:1. Additionally, the loading weight (LW) ratio of the second-first anode mixture layer 311a and the second-second anode mixture layer 311b may be 1:3 to 3:1.

A total loading weight (LW) of the first anode mixture layer 111 may be 4 to 15 mg/cm². Specifically, the loading weight (LW) of the first-first anode mixture layer 111a may be 1.38 to 7.5 mg/cm², and the loading weight (LW) of the first-second anode mixture layer 111b may be 1.38 to 7.5 mg/cm².

The total loading weight (LW) of the second anode mixture layer 311 may be 5 to 20 mg/cm². Specifically, the loading weight (LW) of the second-first anode mixture layer 311a may be 2 to 10.5 mg/cm², and the loading weight (LW) of the second-second anode mixture layer 311b may be 2 to 10.5 mg/cm².

When a value of the loading weight (LW) and a ratio thereof for each anode mixture layer are adjusted as described above, even if content ratios of the silicon-based active material for each layer are different from each other, the content of the silicon-based active material may be adjusted in an appropriate range based on the entire anode, so that a high-capacity anode may be manufactured without causing problems due to volumetric expansion/contraction of the silicon-based active material.

Each of the first anode 11 and the second anode 31 may further include a binder. Specifically, each of the first-first anode mixture layer 111a, the first-second anode mixture layer 111b, the second-first anode mixture layer 311a and the second-second anode mixture layer 311b may include a binder.

The binder may be, for example, a rubber-based binder such as styrene-butadiene rubber (SBR), fluorine-based rubber, ethylene propylene rubber, butyl acrylate rubber, butadiene rubber, isoprene rubber, acrylonitrile rubber, acrylic rubber, silane-based rubber, and/or a water-soluble polymer-based binder such as carboxymethyl cellulose (CMC), hydroxypropyl methyl cellulose, methyl cellulose, polyacrylic acid (PAA), polyvinyl alcohol (PVA), and polyvinyl alcohol-polyacrylic acid copolymer (PVA-PAA Copolymer).

Each of the content of the binder included in the first-first anode mixture layer 111a, the content of the binder included in the first-second anode mixture layer 111b, the content of the binder included in the second-first anode mixture layer 311a, and the content of the binder included in the second-second anode mixture layer 311b may be 0.1 to 5 wt %. In embodiments in which the first-first anode mixture layer 111a does not include a conductive material, a weight of the binder included in the first-first anode mixture layer 111a may be greater than or equal to weights of each of the binders included in the first-second anode mixture layer 111b, the second-first anode mixture layer 311a and the second-second anode mixture layer 311b.

Each of the first anode 11 and the second anode 31 may further include a conductive material. Specifically, each of the first-second anode mixture layer 111b, the second-first anode mixture layer 311a and the second-second anode mixture layer 311b may further include a conductive material. In this case, the first-first cathode mixture layer 111a may include a small amount of conductive materials to the extent that the conductive materials do not have a substantial effect, or may not include the conductive material at all

The first-first cathode mixture layer 111a may include a carbon-based active material, and may substantially not include the silicon-based active material, and may include only a carbon-based active material as the cathode active material. Additionally, in some embodiments, the first-first cathode mixture layer 111a may include a combination of artificial graphite and natural graphite as the carbon-based active material. Accordingly, the first-first anode mixture layer 111a may have sufficiently high electronic conductivity in the composite layer even without including a conductive material, and may further include other components such as a binder in proportion to the content of the excluded conductive material. Accordingly, bonding force between the carbon-based active materials included in the first-first anode mixture layer 111a and adhesive force between the first anode current collector 110 and the first-first anode mixture layer 111a in the first anode mixture layer 111 may be improved.

Examples of the conductive material may include graphite such as natural graphite or artificial graphite; carbon-based materials such as carbon black, acetylene black, ketjen black, channel black, furnace black, lamp black, summer black and carbon nanotubes; metal powder particles or metal fibers such as copper, nickel, aluminum and silver; conductive whiskey such as zinc oxide and potassium titanate; conductive metal oxides such as titanium oxide; or conductive polymers such as polyphenylene derivatives, and one of the examples may be used alone or a mixture of two or more thereof may be used. In some embodiments, the conductive material may be at least one selected from multi-walled carbon nanotubes (MWCNT), single-walled carbon nanotubes (SWCNT), or graphite.

In some embodiments, a conductive material included in the first-second anode mixture layer 111b and the second-second anode mixture layer 311b and a conductive material included in the second-first anode mixture layer 311a may be different from each other. Specifically, the first-second anode mixture layer 111b and the second-second anode mixture layer 311b may include single-walled carbon nanotubes (SWCNT) as the conductive material, and the second-first anode mixture layer 311a may include at least one of the multi-walled carbon nanotubes (MWCNT) or graphite as the conductive material.

In this case, the first-second anode mixture layer 111b and the second-second anode mixture layer 311b, anode upper layers including the silicon-based active material may include single-walled carbon nanotubes (SWCNT), which are conductive materials having high crystallinity and excellent conductivity and dispersibility, thereby more easily forming and maintaining a conductive path that may increase electrical contact between components included in the anode mixture layer. Accordingly, the rapid charging performance of the lithium secondary battery may be improved.

Additionally, the second-first anode mixture layer 311a, an anode lower layer including carbon-based active materials, may include at least one of graphite, conductive materials having low crystallinity, or the multi-walled carbon nanotubes (MWCNT), thereby alleviating problems caused by volumetric expansion of the silicon-based active material.

A content of single-walled carbon nanotubes (SWCNT) included in the first-second anode mixture layer 111b and the second-second anode mixture layer 311b may be 0.05 to 0.5 wt %, respectively.

A content of multi-walled carbon nanotube (MWCNT) included in the second-first anode mixture layer 311a may be 0.2 to 1.5 wt %.

A content of graphite included in the second-first anode mixture layer 311a may be 2 to 4 wt %.

A content of the conductive material included in the first-second anode mixture layer 111b, a content of the conductive material included in the second-first anode mixture layer 311a, and a content of the conductive material included in the second-second anode mixture layer 311b may be 0.01 to 5 wt %, respectively.

A method for manufacturing the first anode 11 and the second anode 31 is not particularly limited, and may be performed by a known method. For example, a first anode slurry including a first-first solvent, a first-first carbon-based active material and a first-first binder may be coated and dried on the first anode current collector 110 by a method such as bar coating, casting, or spraying to form a first-first anode mixture layer 111a, and then, a first-second anode slurry including a first-second solvent, a first-second carbon-based active material, a first-second silicon-based active material, a first-second binder and a first-second conductive material may be coated and dried on the first-first anode mixture layer by a method such as bar coating, casting or spraying, so that the first anode 11 may be manufactured in a manner of the first-second anode mixture layer 111b. The second anode 31 may also be manufactured in the same manner.

As the solvent, for example, dimethyl sulfoxide (DMSO), isopropyl alcohol, N-methylpyrrolidone (NMP), acetone or water may be used, and the amount of the solvent used is sufficient as long as the solvent may dissolve or disperse the active material, the conductive material and the binder in consideration of a coating thickness and a manufacturing yield of a composition for forming an anode mixture layer, and may have a viscosity that may exhibit excellent thickness uniformity during coating for forming the anode mixture layer thereafter.

A first cathode 13 and a second cathode 33 are not particularly limited. For example, the cathode may have a structure including a cathode current collector; and a cathode mixture layer formed on at least one surface of the cathode current collector, and the cathode mixture layer may include a cathode active material.

The components of the cathode current collector are not particularly limited. For example, the cathode current collector may be a plate or a foil formed of one or more of indium (In), copper (Cu), magnesium (Mg), stainless steel, titanium (Ti), iron (Fe), cobalt (Co), nickel (Ni), zinc (Zn), aluminum (Al), germanium (Ge), lithium (Li) and alloys thereof. In some embodiments, the cathode current collector may be an aluminum foil (Al-foil).

A thickness of the cathode current collector is not particularly limited. For example, the thickness of the cathode current collector may be 0.1 μm to 50 μm.

In some embodiments, the cathode active material layer may include a cathode active material. The cathode active material is not particularly limited to an active material produced from the above-described active material precursor, and may include a compound capable of reversibly intercalating and deintercalating lithium ions. For example, the cathode active material may include a lithium-nickel metal oxide. The lithium-nickel metal oxide may further include at least one of cobalt (Co), manganese (Mn) or aluminum (Al).

In some embodiments, the cathode active material or the lithium-nickel metal oxide may include a layered structure or a crystal structure represented by the following chemical formula 1.

LiₓNiₐM_{b}O₂+_{z} [Chemical Formula 1]

In chemical formula 1, 0.9≤x≤1.2, 0.6≤a≤0.99, 0.01≤b≤0.4, −0.5≤z≤0.1 may be satisfied. As described above, M may include Co, Mn, and/or Al.

A chemical structure represented by chemical formula 1 above represents a bonding relationship included in a layered structure or a crystal structure of the cathode active material and does not exclude other additional elements. For example, M includes Co and/or Mn, and Co and/or Mn may be provided as a main active element of the cathode active material together with Ni. The chemical formula 1 is provided to express a bonding relationship of the main active element and should be understood as encompassing the introduction and substitution of additional elements.

In some embodiments, auxiliary elements added to the main active element may be further included to enhance the chemical stability of the cathode active material or the layered structure/crystal structure. The auxiliary elements may be incorporated together in the layered structure/crystal structure to form a bond, in which case it should be understood that the auxiliary elements are included in a chemical structure range represented by the chemical formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P or Zr. The auxiliary element may also act as an auxiliary active element contributing to the capacity/output activity of the cathode active material together with Co or Mn, like Al.

For example, the cathode active material or the lithium-nickel metal oxide may include a layered structure or a crystal structure represented by the following chemical Formula 1-1.

LiₓNiₐM1_{b1}M2_{b2}O_{2+z} [Chemical Formula 1-1]

In Chemical Formula 1-1, M1 may include Co, Mn, and/or Al. M2 may include the auxiliary element described above. In Chemical Formula 1-1, 0.9≤x≤1.2, 0.6≤a≤0.99, 0.01≤b1+b2≤0.4, −0.5≤z≤0.1 may be satisfied.

The cathode active material may further include a coating element or a doping element. For example, elements substantially identical to or similar to the above-described auxiliary elements may be used as the coating element or the doping element. For example, the above-described elements may be used alone or in combination of two or more thereof.

The coating element or the doping element may be present on a surface of lithium-nickel metal oxide particles, or may penetrate through a surface of the lithium-nickel metal oxide particles and may thus be included in a bonding structure represented by Chemical Formula 1 or Chemical Formula 1-1 above.

The cathode active material may include a nickel-cobalt-manganese (NCM)-based lithium oxide. In this case, an NCM-based lithium oxide having an increased nickel content may be used.

A content of Ni (e.g., a mole fraction of nickel among total moles of nickel, cobalt and manganese) in a NCM-based lithium oxide may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include a Mn-rich active material, a Li rich layered oxide (LLO)/Over Lithiated Oxide (OLO) active material, or a Co-less active material having a chemical structure or a crystal structure represented by Chemical Formula 2.

p[Li₂MnO₃]·(1−p)[Li_{q}JO₂] [Chemical Formula 2]

In Chemical Formula 2, 0<p<1 and 0.9≤q≤1.2 may be satisfied, and J may include at least one element among Mn, Ni, Co, Fe, Cr, V, Cu, Zn, Ti, Al, Mg and B.

In some embodiments, the cathode mixture layer may further include a binder. The binder is not particularly limited. For example, the binder may include one kind or two or more kinds of polyvinylidene fluoride (PVDF), styrene butadiene rubber (SBR), polytetrafluoroethylene (PTFE), polyvinylidene fluoride/hexafluoropropylene copolymer, polyacrylonitrile, and polymethylmethacrylate. According to an embodiment, the binder may include polyvinylidene fluoride (PVDF).

The content of the binder included in the cathode mixture layer is not particularly limited. For example, the content of the binder included in the cathode mixture layer may be 0.1 wt % to 10 wt %.

In some embodiments, the cathode mixture layer may further include a conductive material. The conductive material is not particularly limited. For example, the conductive material may include one kind or two or more kinds of graphite such as natural graphite or artificial graphite; carbon-based materials such as carbon black, acetylene black, ketjen black, channel black, furnace black, lamp black, summer black, carbon fiber and carbon nanotube (CNT); metal powder particles or metal fiber such as copper, nickel, aluminum and silver; conductive whiskers such as zinc oxide and potassium titanate; conductive metal oxides such as titanium oxide; or conductive polymers such as polyphenylene derivatives.

The content of the conductive material included in the cathode mixture layer is not particularly limited. For example, the content of the conductive material included in the cathode mixture layer may be 0.1 wt % to 10 wt %.

Each of the first separator 15 and the second separator 35 may be a polyolefin-based polymer separator such as polyethylene, polypropylene, glass fiber, polyester, polytetrafluoroethylene, or combinations thereof, and may be in the form of a nonwoven fabric or a woven fabric. Additionally, the separators may be coated with a composition including ceramic components to secure heat resistance or mechanical strength, and may optionally be formed to have a single-layer or multi-layer structure. In this manner, a known separator in the relevant technical field may be used as the first separator 15 and the second separator 35, and the present disclosure is not limited to the above-described range.

Hereinafter, a structure in which the first electrode group 2 and the second electrode group 4 are assembled will be described in detail with reference to FIG. 1 and FIGS. 3A to 4E.

### Electrode Group Assembly Structure

FIG. 1 is a perspective view conceptually illustrating an assembly structure of a first unit cell and a second unit cell according to an embodiment.

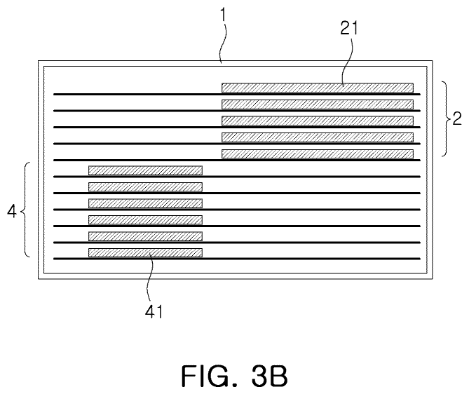

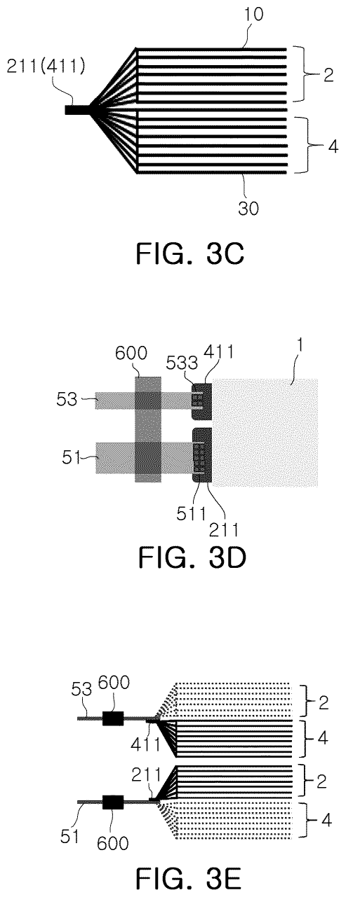

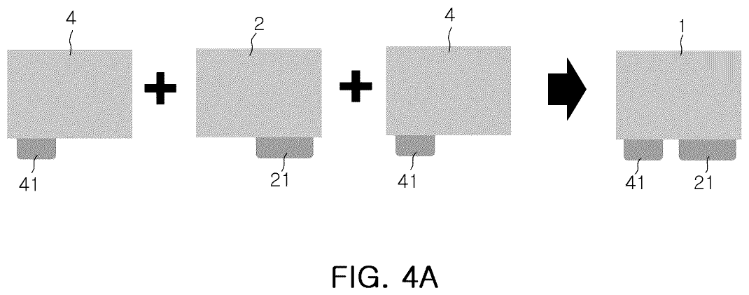

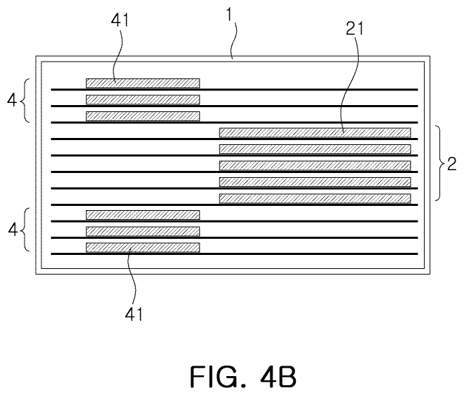

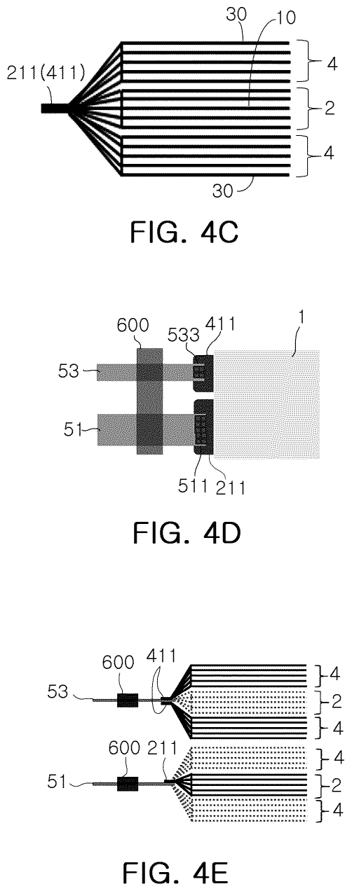

FIGS. 3A and 4A are plan views respectively illustrating a shape in which an assembly structure of a first electrode group and a second electrode group according to embodiments is observed from an upper surface.

FIGS. 3B and 4B are front views respectively illustrating a form in which an assembly structure of a first electrode group and a second electrode group according to embodiments is observed based on a surface from which an anode non-coated portion protrudes.

FIGS. 3C and 4C are views respectively illustrating a form in which an assembly structure of a first electrode group and a second electrode group in an electrode assembly according to embodiments is observed from a side surface.

FIGS. 3D and 4D are plan views respectively illustrating a form in which a connection structure between electrode tabs and electrode leads of each electrode group in an electrode assembly according to embodiments is observed from an upper surface.

FIGS. 3E and 4E are views respectively illustrating a form in which a connection structure between electrode tabs and electrode leads of each electrode group in an electrode assembly according to embodiments is observed from a side surface.

In the lithium secondary battery according to an embodiment, each of the first unit cell 10 and the second unit cell 30 may include a non-coated portion protruding in the same direction with respect to electrodes having the same polarity (see FIGS. 1, 3A to 3B and 4A to 4B). Specifically, each of the first anode 11 and the second anode 31 may include a first anode non-coated portion 21 and a second anode non-coated portion 41 protruding in the same direction. Additionally, each of the first cathode 13 and the second cathode 33 may include a first cathode non-coated portion 23 and a second cathode non-coated portion 43 protruding in the same direction (a direction different from a direction in which the first anode non-coated portion 21 and the second anode non-coated portion 41 protrude).

The first anode non-coated portion 21 and the second anode non-coated portion 41 may be formed in different positions based on a protruding surface. Specifically, the first anode non-coated portion 21 may be formed on a right side based on the protruding surface, and the second anode non-coated portion 41 may be formed on a left side based on the protruding surface (see FIG. 1, FIGS. 3A to 3B, and FIGS. 4A to 4B), and vice versa.

The first cathode non-coated portion 23 and the second cathode non-coated portion 43 may be formed in different positions based on the protruding surface. Specifically, the first cathode non-coated portion 23 may be formed on the left side based on the protruding surface, and the second cathode non-coated portion 43 may be formed on the right side based on the protruding surface (see FIG. 1, FIGS. 3A to 3B, and FIGS. 4A to 4B), and vice versa.

In this manner, the first anode non-coated portion 21 and the second anode non-coated portion 41; and the first cathode non-coated portion 23 and the second cathode non-coated portion 43 may formed in different positions in a protruding surface direction with respect to the electrodes having the same polarity (specifically, each component being biased to a left/right axis), and the utilization of an internal space may be maximized through an electrode design for connecting each electrode tab described below to a plurality of independent electrode leads, and the energy density of each electrode group and electrode assembly may be significantly improved.

A width of the first anode non-coated portion 21 and a width of the second anode non-coated portion 41 may be 15 mm to 45 mm. Additionally, a width of the first cathode non-coated portion 23 and a width of the second cathode non-coated portion 43 may be 15 mm to 45 mm.

A thickness of the first anode non-coated portion 21 and a thickness of the second anode non-coated portion 41 may be 6 μm to 20 μm. Additionally, a thickness of the first cathode non-coated portion 23 and a thickness of the second cathode non-coated portion 43 may be 8 μm to 20 μm.

Meanwhile, an electrode group assembly structure according to an embodiment is a structure in which a first electrode group 2 including one or more of the first unit cells 10; and a second electrode group 4 including one or more of the second unit cells 30 are alternately assembled, and may be a structure arranged in the order of ‘˜first electrode group-second electrode group-first electrode group-second electrode group˜’ (A-B-A-B) (see FIGS. 3A to 3E).

Additionally, an electrode group assembly structure according to another embodiment is a structure in which a second electrode group 4 including one or more of the second unit cells 30, a first electrode group 2 including one or more of the first unit cells 10, and a second electrode group 4 including one or more of the second unit cells 30 are alternately assembled, and may be a structure arranged in the order of ‘˜second electrode group-first electrode group-second electrode group-second electrode group-first electrode group-second electrode group˜’ (B-A-B-B-A-B) (see FIGS. 4A to 4E).

A lithium secondary battery according to an embodiment may include an electrode assembly 1 satisfying the condition of the following equation 1.

$$0.1 < A 1 / A 2 < 3.0 \qquad [ Formula 1 ]$$

In Formula 1, A1 is a total number of the first unit cells, and A2 is a total number of the second unit cells.

Specifically, an A1/A2 value may be 1.0 to 2.5, or 1.5 to 2.0. Additionally, an A1 value may be 1 to 40, or 10 to 30. Additionally, an A2 value may be 1 to 20, or 5 to 15.

A lithium secondary battery according to an embodiment may include an electrode assembly 1 satisfying a condition of the following formula 2.

$$0. 1 < B 1 / B 2 < 3.0 \qquad [ Formula 2 ]$$

In Formula 2, B1 is a total number of the first electrode group, and B2 is a total number of the second electrode group. Specifically, a B1/B2 value may be 0.3 to 1.0.

When a ratio of the total number of each of the first unit cells 10 and the second unit cells 30, a ratio of the total number of the first electrode group 2 and the second electrode group 4, and the like, are in the above-described range, the number of first unit cells and first electrode group having excellent high-rate characteristics and excellent volumetric expansion control characteristics and the number of second unit cells and second electrode group having excellent capacity characteristics and excellent lifespan characteristics may be appropriately adjusted to manufacture a hybrid secondary battery having excellent high-rate characteristics, volumetric expansion control characteristics, capacity characteristics, life characteristics.

In the first electrode group 2 including one or more first unit cells 10, the first anode non-coated 21 included in each of the first unit cells 10 may be coupled to form a first anode tab 211. That is, the lithium secondary battery may include the first anode tab 211 formed by combining one or more first anode non-coated portions 21. Similarly, in the second electrode group 4 including one or more second unit cells 30, the second anode non-coated portions 41 included in each second unit cell 30 may be coupled to form a second anode tab 411. That is, the lithium secondary battery may include the second anode tab 411 formed by combining one or more second anode non-coated portions 41.

The first anode tab 211 and the second anode tab 411 may be connected to a first anode lead 51 and a second anode lead 53 different from each other, respectively. Specifically, the first anode lead and the second anode lead may be arranged in parallel with each other, and the first anode lead 51 and the second anode lead 53 may be connected to one lead film 600. Accordingly, the first unit cell 10 and the second unit cell 30 may be connected to independent electrode leads, and depending on the design purpose, currents having different sizes may be input or output simultaneously or independently to or from one battery.

The first anode tab 211 and the first anode lead 51 may be connected through a first coupling portion 511 formed therebetween, and the second anode tab 411 and the second anode lead 53 may be connected through a second coupling portion 533 formed therebetween. The first coupling portion 511 and the second coupling portion 533 may be formed to be paths for an input and an output of currents, and sizes thereof (thickness, width, length, and the like) may be formed differently from each other, thereby reducing internal resistance.

The first coupling portion 511 and the second coupling portion 533 may include different materials. For example, only one of the first coupling portion 511 and the second coupling portion 533 may include a resistance-reducing coating layer, but are not limited thereto.

In the case of an electrode assembly structure according to an embodiment (see FIGS. 3A to 3E), the first anode tab 211 disposed in an upper portion in a thickness direction based on the first anode lead 51 may be coupled to an upper portion of the first anode lead 51, and the first coupling portion 511 may be formed in the upper portion of the first anode lead 51. On the other hand, the second anode tab 411 disposed in a lower portion in the thickness direction based on the second anode lead 53 may be coupled to a lower portion of the second anode lead 53, so that the second coupling portion 533 may be formed in the lower portion of the second anode lead 53.

In the case of the electrode group assembly structure according to another embodiment (see FIGS. 4A to 4E), the first anode tab 211 disposed in the upper portion in the thickness direction based on the first anode lead 51 may be coupled to the upper portion of the first anode lead 51, so that the first coupling portion 511 may be formed in the upper portion of the first anode lead 51. On the other hand, the second anode tab 411 disposed in an upper portion in the thickness direction based on the second anode lead 53 may be coupled to an upper portion of the second anode lead 53, and the second anode tab 411 disposed in the lower portion may be coupled to the lower portion of the second anode lead 53. Accordingly, the second coupling portion 533 may be formed in both the upper portion and the lower portion of the second anode lead 53.

The electrode group assembly structure, the electrode tab-electrode lead connection structure, and the like, disclosed in this specification, are not limited to the above-described embodiments, and may be configured differently depending on the design purpose.

When the assembly structure and the connection structure described above are applied, even if a plurality of electrode groups are assembled, asymmetrical expansion of the non-coated portion, or the like, may be prevented, from which problems such as a breakage of the non-coated portion may be substantially alleviated.

The technical features of the anode tab, the anode lead, and the coupling portion described above may be applied equally to a cathode, and since detailed description thereof would be redundant, descriptions thereof will be omitted.

A lithium secondary battery according to an embodiment may be manufactured by inserting an electrode assembly 1 including a structure in which the first electrode group 2 and the second electrode group 4 are alternately assembled into a battery case, and then injecting an electrolyte thereinto.

An electrode assembly 1 may be a stack type, a lamination/stack type, or a stack/folding type electrode assembly.

A battery case normally used in the relevant field may be applied to the battery case described above. For example, the battery case may be cylindrical, square, pouch-shaped or coin-shaped. Additionally, the battery case may have a structure in which an insulating layer, an adhesive layer, a metal film, and the like, are assembled. The metal film may include aluminum (Al) or the like to secure the mechanical strength of the case and block moisture and oxygen.

The electrolyte includes an organic solvent and a lithium salt. The organic solvent acts as a medium through which ions involved in an electrochemical reaction of the battery may move, and for example, a carbonate-based solvent, an ester-based solvent, an ether-based solvent, a ketone-based solvent, an alcohol-based solvent or an aprotic solvent may be used alone or in combination of two or more thereof, and a mixing ratio in the case of mixing and using two or more types of the solvents may be appropriately adjusted according to intended battery performance. The lithium salt is a material dissolved in an organic solvent and acting as a source of lithium ions in the battery, and enabling a basic operation of a lithium secondary battery and promoting a movement of lithium ions between the cathode and the anode. As the lithium salt, a known material may be used in a concentration suitable for the purpose. The electrolyte may further include a known solvent to improve charge/discharge characteristics and flame retardancy characteristics as needed, and may include a known additive.

### Battery Module and Pack

A secondary battery module according to an embodiment includes the lithium secondary battery described above. Specifically, the secondary battery module is a battery module including a plurality of lithium secondary batteries described above, and may include a plurality of electrode assemblies in which two types of electrode groups having different electrochemical performances are alternately assembled, so that life characteristics, rapid charging characteristics and energy density may all be excellent.

A secondary battery pack according to an embodiment includes the secondary battery module. Specifically, the secondary battery pack may be used as a battery pack in which a plurality of secondary battery modules including the lithium secondary batteries described above are coupled and connected, and may be excellently utilized as a power source for medium and large-sized devices such as a power tool, an electric vehicle (EV), a hybrid electric vehicle (HEV) and a plug-in hybrid electric vehicle (PHEV).

### EXAMPLE

### 1) Manufacturing of Unit Cell

A first unit cell and a second unit cell including a multilayered-structure anode having a coating ratio (based on loading weight) for each anode mixture layer, and the types and contents of silicon-based active materials and carbon-based active materials as illustrated in Tables 1 and 2 below, were manufactured according to each of Inventive Examples and Comparative Examples.

### 2) Manufacturing of Electrode Assembly

One first electrode group including 20 first unit cells; and two second electrode groups including 11 second unit cells were assembled alternately to manufacture a stacked electrode assembly as illustrated in FIGS. 4A to 4E. Meanwhile, the non-coated portions having the same polarity were assembled so that protrusion directions are formed to have the same direction in parallel, and the protrusion positions of the non-coated portions were arranged in different positions depending on the configuration of the unit cells. Specifically, the non-coated portion (first cathode non-coated portion) of the first electrode group including the first unit cells was configured to be biased to the right, and the non-coated portion (second cathode non-coated portion) of the second electrode group including the second unit cells was configured to be biased to the left. A gap between the first anode non-coated portion in the first electrode group and the second anode non-coated portion in the second electrode group was configured to be maintained to be 8.0 mm in consideration of safety during charging and discharging, and a width of the first cathode non-coated portion was manufactured to be 35.0 mm, and a width of the second anode non-coated portion was manufactured to be 25.0 mm.

Next, the first anode tab formed by coupling the first anode non-coated portion in the first electrode group through ultrasonic fusion was connected to the first anode lead, and the second anode tab formed by coupling the second anode non-coated portion in the second electrode group was connected to the second anode lead. In this case, the first anode tab was connected to be disposed in an upper portion of the first anode lead in the thickness direction, and the second anode tab was connected to be disposed an upper portion and a lower portion of the second anode lead in the thickness direction, respectively (see FIG. 4E). In this manner, when the anode tab was ultrasonically fused with the anode lead, the anode tab may be fused and bonded to the upper and lower portions of each anode lead, so that a degree of elongation of each of the plurality of non-coated portions may be equally controlled, thereby minimizing occurrence of defects such as tearing of base materials.

### 3) Manufacturing of Secondary Battery

Each manufactured electrode assembly was inserted into a pouch case, and three surfaces of the case were sealed except an electrolyte injection surface. In this case, a portion having the electrode tab was sealed to be included in a sealing portion. The electrolyte was injected through the remaining surfaces except the sealing portion, and the remaining surfaces were sealed, and then impregnated for 12 hours or more. The electrolyte was prepared and used by dissolving 1.1 M LiPF₆ in a mixed solvent of EC/EMC (25/75; volume ratio), and adding 8 wt % of fluoroethylene carbonate (FEC), 0.5 wt % of 1,3-propene sultone (PRS), and 1.0 wt % of 1,3-propane sultone (PS) thereto. Then, Heat Press Pre-charging was performed for 60 minutes at an average current of 0.5C. After stabilization for 12 hours or more, degassing was performed, and after aging for 24 hours more than, chemical charge/discharge was performed (charge conditions: CC-CV, 0.25C, 4.2V, 0.05C, CUT-OFF; discharge conditions: CC, 0.25C, 2.5V, CUT-OFF). Then, standard charge and discharge were performed (charge conditions: CC-CV, 0.33C, 4.2V, 0.05C, CUT-OFF; discharge conditions: CC, 0.33C, 2.5V, CUT-OFF).

| | First Electrode Group | | | | | |
|---|---|---|---|---|---|---|
| | Characteristics for each upper layer and | | | | | Content of |
| | each lower layer of a first unit cell | | | | | Si-based |
| | | | | | Upper | active |
| | Carbon-based | | Si-based | | Layer:Lower | material |
| | active | | active | Whether to | Layer | based on |
| | material | | material | include | material | the enitre |
| | | Content | Type and | conductive | Coating | first unit |
| Division | Type | Ratio | Content | material | Ratio (%) | cell |
| Inventive | Upper | — | Upper Layer: | ◯ | 75:25 | 6 wt % |
| Example 1 | Layer: | | C | | (3:1) | |
| | A | | (8 wt %) | | | |
| | Lower | 7:3 | Lower Layer: | X | | |
| | Layer: | | — | | | |
| | A + B | | | | | |
| Inventive | Upper | — | Upper Layer: | ◯ | 50:50 | 6 wt % |
| Example 2 | Layer: | | C | | (1:1) | |
| | A | | (12 wt %) | | | |
| | Lower | 7:3 | Lower Layer: | X | | |
| | Layer: | | — | | | |
| | A + B | | | | | |
| Inventive | Upper | — | Upper Layer: | ◯ | 50:50 | 6 wt % |
| Example 3 | Layer: | | C | | (1:1) | |
| | A | | (12 wt %) | | | |
| | Lower | 5:5 | Lower Layer: | X | | |
| | Layer: | | — | | | |
| | A + B | | | | | |
| Inventive | Upper | — | Upper Layer: | ◯ | 50:50 | 6 wt % |
| Example 4 | Layer: | | C | | (1:1) | |
| | A | | (12 wt %) | | | |
| | Lower | — | Lower Layer: | ◯ | | |
| | Layer: | | — | | | |
| | A | | | | | |
| Inventive | Upper | — | Upper Layer: | ◯ | 50:50 | 6 wt % |
| Example 5 | Layer: | | C | | (1:1) | |
| | A | | (12 wt %) | | | |
| | Lower | 7:3 | Lower Layer: | ◯ | | |
| | Layer: | | — | | | |
| | A + B | | | | | |
| Comparative | Upper | — | Upper Layer: | ◯ | 25:75 | 6 wt % |
| Example 1 | Layer: | | C | | (1:3) | |
| | A | | (24 wt %) | | | |
| | Lower | 7:3 | Lower Layer: | X | | |
| | Layer: | | — | | | |
| | A + B | | | | | |
| Comparative | Upper | — | Upper Layer: | ◯ | 50:50 | 6 wt % |
| Example 2 | Layer: | | C | | (1:1) | |
| | A | | (6 wt %) | | | |
| | Lower | 7:3 | Lower Layer: | X | | |
| | Layer: | | C | | | |
| | A + B | | (6 wt %) | | | |
| Comparative | Upper | — | Upper Layer: | ◯ | 50:50 | 6 wt % |
| Example 3 | Layer: | | C | | (1:1) | |
| | A | | (6 wt %) | | | |
| | Lower | — | Lower Layer: | X | | |
| | Layer: | | — | | | |
| | A | | | | | |
| Comparative | Upper | — | Upper Layer: | ◯ | 50:50 | 6 wt % |
| Example 4 | Layer: | | C | | (1:1) | |
| | A | | (12 wt %) | | | |
| | Lower | 7:3 | Lower Layer: | X | | |
| | Layer: | | — | | | |
| | A + B | | | | | |
| Comparative | Upper | — | Upper Layer: | ◯ | 50:50 | 6 wt % |
| Example 5 | Layer: | | C | | (1:1) | |
| | A | | (12 wt %) | | | |
| | Lower | 7:3 | Lower Layer: | X | | |
| | Layer: | | — | | | |
| | A + B | | | | | |

※ Carbon-based active material: A = artificial graphite, B = natural graphite
※ Silicon-based active material: A = SiOx (0 < x < 2), B = Mg-doped SiOx (0 < x < 2), C = Si—C composite
※ Upper conductive material: Single-walled carbon nanotube (SWCNT)
※ Lower conductive material: Multi-walled carbon nanotube (MWCNT)

TABLE 2

| | Second Electrode Group | | | | | |
|---|---|---|---|---|---|---|
| | Characteristics for each upper layer and | | | | | Content of |
| | each lower layer of a second unit cell | | | | | Si-based |
| | Carbon-based | | Si-based | | Upper | active |
| | active | | active | Whether to | Layer:Lower | material |
| | material | | material | include | Layer | based on the |
| | | Content | Type and | conductive | Coating | entire second |
| Division | Type | Ratio | Content | material | Ratio (%) | unit cell |
| Inventive | Upper | — | Upper Layer: | ◯ | 50:50 | 6 wt % |
| Example 1 | Layer: | | B | | (1:1) | |
| | A | | (10 wt %) | | | |
| | Lower | — | Lower Layer: | ◯ | | |
| | Layer: | | A | | | |
| | A | | (2 wt %) | | | |
| Inventive | Upper | — | Upper Layer: | ◯ | 50:50 | 6 wt % |
| Example 2 | Layer: | | B | | (1:1) | |
| | A | | (10 wt %) | | | |
| | Lower | — | Lower Layer: | ◯ | | |
| | Layer: | | A | | | |
| | A | | (2 wt %) | | | |
| Inventive | Upper | — | Upper Layer: | ◯ | 50:50 | 6 wt % |
| Example 3 | Layer: | | B | | (1:1) | |
| | A | | (10 wt %) | | | |
| | Lower | — | Lower Layer: | ◯ | | |
| | Layer: | | A | | | |
| | A | | (2 wt %) | | | |
| Inventive | Upper | — | Upper Layer: | ◯ | 50:50 | 6 wt % |
| Example 4 | Layer: | | B | | (1:1) | |
| | A | | (10 wt %) | | | |
| | Lower | — | Lower Layer: | ◯ | | |
| | Layer: | | A | | | |
| | A | | (2 wt %) | | | |
| Inventive | Upper | — | Upper Layer: | ◯ | 50:50 | 6 wt % |
| Example 5 | Layer: | | B | | (1:1) | |
| | A | | (10 wt %) | | | |
| | Lower | — | Lower Layer: | ◯ | | |
| | Layer: | | A | | | |
| | A | | (2 wt %) | | | |
| Comparative | Upper | — | Upper Layer: | ◯ | 50:50 | 6 wt % |
| Example 1 | Layer: | | B | | (1:1) | |
| | A | | (10 wt %) | | | |
| | Lower | — | Lower Layer: | ◯ | | |
| | Layer: | | A | | | |
| | A | | (2 wt %) | | | |
| Comparative | Upper | — | Upper Layer: | ◯ | 50:50 | 6 wt % |
| Example 2 | Layer: | | B | | (1:1) | |
| | A | | (10 wt %) | | | |
| | Lower | — | Lower Layer: | ◯ | | |
| | Layer: | | A | | | |
| | A | | (2 wt %) | | | |
| Comparative | Upper | — | Upper Layer: | ◯ | 50:50 | 6 wt % |
| Example 3 | Layer: | | B | | (1:1) | |
| | A | | (10 wt %) | | | |
| | Lower | — | Lower Layer: | ◯ | | |
| | Layer: | | A | | | |
| | A | | (2 wt %) | | | |
| Comparative | Upper | — | B | ◯ | 100:0 | 6 wt % |
| Example 4 | Layer: | | (6 wt %) | | | |
| | A | | | | | |
| | Lower | — | | ◯ | | |
| | Layer: | | | | | |
| | A | | | | | |
| Comparative | Upper | — | A | ◯ | 100:0 | 6 wt % |
| Example 5 | Layer: | | (6 wt %) | | | |
| | A | | | | | |
| | Lower | — | | ◯ | | |
| | Layer: | | | | | |
| | A | | | | | |

※ Carbon-based active material: A = artificial graphite
※ Silicon-based active material: A = SiOx, B = Mg-doped SiOx, C = Si—C composite
※ Upper conductive material: Single-walled carbon nanotube (SWCNT)
※ Lower conductive material: Multi-walled carbon nanotube (MWCNT)

### 4) Performance Evaluation

### (1) Energy Density

The lithium secondary batteries manufactured according to Inventive Examples 1 to 5 and Comparative Examples 1 to 5 were charged with a constant current until a voltage reached 4.2V with a current of 0.3C rate, and then were charged with a constant voltage by cutting off the current at 0.05C rate while maintaining 4.2V in a constant voltage mode. Then, the lithium secondary battery was discharged with a constant current of 0.3C rate until a voltage reached 2.5V, and then the discharge capacity (Ah) and energy (Wh) were measured, and then the discharge capacity (Ah) and the energy (Wh) were measured, and volume-energy density was calculated by measuring volume of each battery in the 4.2 V charged state, and results thereof are illustrated in Table 3 below.

TABLE 3

| | Total number | Number of | Number of | Energy |
|---|---|---|---|---|
| | of stacks of | first unit | second unit | Density |
| Division | an anode | cell stacks | cell stacks | (Wh/L) |
| Inventive | 42 | 20 | 22 | 714 |
| Example 1 | | | | |
| Inventive | 42 | 20 | 22 | 715 |
| Example 2 | | | | |
| Inventive | 42 | 20 | 22 | 717 |
| Example 3 | | | | |
| Inventive | 42 | 20 | 22 | 713 |
| Example 4 | | | | |
| Inventive | 42 | 20 | 22 | 713 |
| Example 5 | | | | |
| Comparative | 42 | 20 | 22 | 712 |
| Example 1 | | | | |
| Comparative | 42 | 20 | 22 | 714 |
| Example 2 | | | | |
| Comparative | 42 | 20 | 22 | 713 |
| Example 3 | | | | |
| Comparative | 42 | 20 | 22 | 711 |
| Example 4 | | | | |
| Comparative | 42 | 20 | 22 | 710 |
| Example 5 | | | | |

### (2) Evaluation of Electrode Volumetric Expansion Rate and Electrode Detachment

The lithium secondary batteries manufactured according to Inventive Examples 1 to 5 and Comparative Examples 1 to 5 were charged (CC/CV 0.1C 0.01V (vs. Li) 0.01C CUT-OFF) at room temperature (25° C.), and were then disassembled to measure thicknesses of the charged first unit cell and the charged second unit cell.

Anode thicknesses (SOC 0%, t₁) of the first unit cell and the second unit cell that were not charged and anode thicknesses (SOC 100%, t₂) of the charged first unit cell and the charged second unit cell were measured, and electrode volumetric expansion rate was calculated using Equation 3 below, and results thereof are illustrated in Table 4 below.

$$Expansion rate ( \% ) = ( {t}_{2} - {t}_{1} ) / ( {t}_{1} - collector thickness ) \times 100 \qquad [ Formula 3 ]$$

In Formula 3, a thickness of the collector is a thickness of an anode collector used in the manufacture of the secondary battery anode.

The charged first unit cell and the charged second unit cell were left at room temperature (25° C.) for 10 minutes without a separate washing process, and a condition of bonding surface between an anode current collector and a anode mixture material layer was visually confirmed, and results thereof are illustrated in Table 4 below. When there was no electrode detachment upon visual confirmation of the charged first unit cell and the charged second unit cell, this was marked as “-”.

TABLE 4

| | Volumetric | | Electrode | |
|---|---|---|---|---|
| | expansion Rate (%) | | Detachment | |
| | First Unit | Second Unit | First Unit | Second Unit |
| Division | Cell | Cell | Cell | Cell |
| Inventive | 23.4 | 31.8 | — | — |
| Example 1 | | | | |
| Inventive | 22.8 | 31.8 | — | — |
| Example 2 | | | | |
| Inventive | 21.9 | 31.8 | — | — |
| Example 3 | | | | |
| Inventive | 23.6 | 31.8 | — | — |
| Example 4 | | | | |
| Inventive | 23.3 | 31.8 | — | — |
| Example 5 | | | | |
| Comparative | 25.7 | 31.8 | Detached | — |
| Example 1 | | | | |
| Comparative | 23.1 | 31.8 | — | — |
| Example 2 | | | | |
| Comparative | 23.2 | 31.8 | — | — |
| Example 3 | | | | |
| Comparative | 22.8 | 32.3 | — | — |
| Example 4 | | | | |
| Comparative | 22.8 | 32.9 | — | Detached |
| Example 5 | | | | |

### (3) Resistance Characteristics

The lithium secondary batteries manufactured according to Inventive Examples 1 to 5 and Comparative Examples 1 to 5 were discharged for 10 seconds at 1C current after a rest period of 1 hour after adjusting the SOC to 50% at 25° C., and the resistance characteristics were measured, and results thereof are shown in Table 5. Specifically, resistance values of lithium secondary battery samples were measured according to the following Equation 4, and results thereof are shown in Table 5.

$$R = ( {V}_{0} - {V}_{1} ) / I \qquad [ Equation 4 ]$$

In Equation 4, R represents a resistance value of the lithium secondary battery, V₀ represents the voltage of the lithium secondary battery measured after adjusting the SOC to 50% at 25° C. and a rest period of 1 hour, V₁ represents the voltage of the lithium secondary battery measured after discharging for 10 seconds at 1C current, and I is a 1C current value.

### (4) Output Characteristics

For the lithium secondary batteries manufactured in Inventive Examples 1 to 5 and Comparative Examples 1 to 5, charging (CC/CV 0.3C 4.2V 0.05C CUT-OFF) and discharging (CC 0.3C 2.5V CUT-OFF) were performed twice at room temperature (25° C.). Then, the discharge (CC 0.3C) was performed from a charging (CC/CV 0.3C 4.2V 0.05C CUT-OFF) state to a SOC 50% point, and outputs (W/kg) during discharging and charging at the SOC 50% point were measured, and results thereof are illustrated in Table 5 below.

TABLE 5

| | | Discharging | Charging |
|---|---|---|---|
| | Resistance | Output | Output |
| Division | (mΩ) | (W/kg) | (W/kg) |
| Inventive Example 1 | 1.08 | 3329.3 | 2634.7 |
| Inventive Example 2 | 1.11 | 3271.4 | 2577.2 |
| Inventive Example 3 | 1.12 | 3269.9 | 2580.3 |
| Inventive Example 4 | 1.10 | 3283.9 | 2662.5 |
| Inventive Example 5 | 1.10 | 3280.5 | 2594.1 |
| Comparative Example 1 | 1.09 | 3263.1 | 2443.7 |
| Comparative Example 2 | 1.12 | 3269.2 | 2561.4 |
| Comparative Example 3 | 1.09 | 3292.8 | 2647.9 |
| Comparative Example 4 | 1.11 | 3267.6 | 2439.5 |
| Comparative Example 5 | 1.13 | 3285.7 | 2511.7 |

### (5) Lifespan Characteristics (Normal Lifespan/Rapid Charging Lifespan)

### [Evaluation of Normal Lifespan Characteristics]

The lithium secondary batteries manufactured according to Inventive Examples 1 to 5 and Comparative Examples 1 to 5 were evaluated for normal charge lifespan characteristics in a SOC 4%-98% range in a chamber maintained at 25° C. The battery were charged at 0.3C to a voltage corresponding to SOC 98% under constant current/constant voltage (CC/CV) conditions, then cut off at 0.05C, and then discharged at 0.3C to a voltage corresponding to SOC 4% under constant current (CC) conditions, and discharge capacity thereof was measured. After repeating this process for 500 cycles, a discharge capacity retention rate of a normal (room temperature) lifespan characteristics evaluation was measured, and results thereof are illustrated in Table 6 below.

### [Evaluation of Rapid Charge Lifespan Characteristics]

The lithium secondary batteries manufactured according to Inventive Examples 1 to 5 and Comparative Examples 1 to 5 were charged at a C-rate ranging from 3.25C/3.0C/0.75C/2.5C/2.25C/2.0C/1.75C/1.5C/1.25C/1.0C/0.75C/0.5C according to a Step charging method to reach DOD 72 within 25 minutes, and then discharged at ⅓C. The charge and discharge were considered as 1 cycle, and the rapid charge evaluation was performed by repeating the cycle. After repeating 300 cycles with a waiting time of 10 minutes between charge and discharge cycles, the rapid charge capacity retention rate was measured, and results thereof are illustrated in Table 6 below.

When the discharge capacity was so low that measurement was difficult before performing 300 charge and discharge cycles, this was indicated as “-”.

TABLE 6

| | General | Fast |
|---|---|---|
| | Lifespan Capacity | Charge Capacity |
| | Retention Rate | Retention Rate |
| Division | (500 cycles; %) | (300 cycles; %) |
| Inventive Example 1 | 93.6 | 96.6 |
| Inventive Example 2 | 93.3 | 96.1 |
| Inventive Example 3 | 93.4 | 95.9 |
| Inventive Example 4 | 93.7 | 96.4 |
| Inventive Example 5 | 93.1 | 96.4 |
| Comparative Example 1 | 92.9 | 96.3 |
| Comparative Example 2 | 93.5 | 95.4 |
| Comparative Example 3 | 94.1 | 96.7 |
| Comparative Example 4 | 92.4 | 94.2 |
| Comparative Example 5 | 92.8 | 93.9 |

Referring to Tables 1 to 6, when the content of the silicon-based active material included in the first-second anode mixture layer exceeds 23 wt % based on the total weight of the first-second anode mixture layer (Comparative Example 1), it may be confirmed that a volumetric expansion ratio of the first unit cell is very large and the electrode detachment phenomenon occurs in the first unit cell. Additionally, when the content of the silicon-based active material included in the first-second anode mixture layer is less than 7 wt % based on the total weight of the first-second anode mixture layer, it may be confirmed that the output characteristics are relatively low (Comparative Example 2) or the energy density is low (Comparative Example 3).

Additionally, in the case of Comparative Examples 4 and 5 in which the second anode mixture layer has a single-layer structure, it may be confirmed that the volumetric expansion ratio of the second unit cell is very large and the output characteristics are relatively low. Specifically, in the case of Comparative Example 5, the electrode detachment phenomenon was also confirmed in the second unit cell.

On the other hand, in the case of Inventive Examples 1 to 5 in which the content of the silicon-based active material included in the first-second anode mixture layer is 7 to 23 wt % based on the total weight of the first-second anode mixture layer, and the weight of the silicon-based active material included in the second-second anode mixture layer is greater than or equal to the weight of the silicon-based active material included in the second-first anode mixture layer, it may be confirmed that the energy density, resistance characteristics, output characteristics, lifespan characteristics, and rapid charging characteristics of the lithium secondary battery are evenly excellent.

What is claimed is:

1. A lithium secondary battery, comprising:
an electrode assembly in which a first electrode group including one or more first unit cells, and a second electrode group including one or more second unit cells are alternately assembled,
wherein the first unit cell includes a first anode current collector, and a first anode including a first anode mixture layer on the first anode current collector,
the first anode mixture layer includes a first-first anode mixture layer on the first anode current collector, and a first-second anode mixture layer on the first-first anode mixture layer,
the second unit cell includes a second anode current collector; and a second anode including a second anode mixture layer on the second anode current collector,
the second anode mixture layer includes a second-first anode mixture layer on the second anode current collector, and a second-second anode mixture layer on the second-first anode mixture layer,
the first-first anode mixture layer includes a carbon-based active material,
each of the first-second anode mixture layer, the second-first anode mixture layer and the second-second anode mixture layer includes a silicon-based active material,
an amount of the silicon-based active material included in the first-second anode mixture layer is 7 to 23 wt % based on a total weight of the first-second anode mixture layer, and,
a weight of the silicon-based active material included in the second-second anode mixture layer is greater than or equal to a weight of the silicon-based active material included in the second-first anode mixture layer.

2. The lithium secondary battery of claim 1,
wherein the first-first anode mixture layer includes a combination of artificial graphite and natural graphite as a carbon-based active material.

3. The lithium secondary battery of claim 2,
wherein a weight of the artificial graphite included in the first-first anode mixture layer is greater than or equal to the weight of the natural graphite.

4. The lithium secondary battery of claim 1,
wherein the first-first anode mixture layer does not include the silicon-based active material.

5. The lithium secondary battery of claim 1,
wherein each of the first-second anode mixture layer, the second-first anode mixture layer and the second-second anode mixture layer further includes a carbon-based active material.

6. The lithium secondary battery of claim 5,
wherein a weight of the carbon-based active material included in the first-first anode mixture layer is greater than or equal to weights of each carbon-based active material included in the first-second anode mixture layer, the second-first anode mixture layer and the second-second anode mixture layer.

7. The lithium secondary battery of claim 1,
wherein the silicon-based active material is at least one selected from the group consisting of Si, SiOx (0≤x≤2), a Si-Q alloy (where Q is an element selected from the group consisting of an alkali metal, an alkaline earth metal, a Group 13 element, a Group 14 element, a Group 15 element, a Group 16 element, a transition metal, a rare earth element, and combinations thereof, but is not Si), and a Si—C composite.

8. The lithium secondary battery of claim 1,
wherein the first-second anode mixture layer includes a first-second silicon-based active material as a silicon-based active material,
the second-first anode mixture layer includes a second-first silicon-based active material as a silicon-based active material, and
the second-second anode mixture layer includes a second-second silicon-based active material as a silicon-based active material,
wherein at least two kinds of the first-second silicon-based active material, the second-first silicon-based active material and the second-second silicon-based active material are different from each other.

9. The lithium secondary battery of claim 8,
wherein the first-second silicon-based active material, the second-first silicon-based active material, and the second-second silicon-based active material are all different from each other.

10. The lithium secondary battery of claim 1,
wherein the first-second silicon-based active material is a Si—C composite.

11. The lithium secondary battery of claim 1,
wherein the second-first silicon-based active material is SiOx (0<x<2).

12. The lithium secondary battery of claim 1,
wherein the second-second silicon-based active material is metal-doped SiOx (0<x<2).

13. The lithium secondary battery of claim 1,
wherein a content of the silicon-based active material in the first anode mixture layer is 0.1 to 30 wt % based on a total weight of the first anode mixture layer.

14. The lithium secondary battery of claim 1,
wherein a content of the silicon-based active material in the second anode mixture layer is 0.1 to 30 wt % based on a total weight of the second anode mixture layer.

15. The lithium secondary battery of claim 1,
wherein a content of the silicon-based active material included in the second-first anode mixture layer is 1 to 8 wt % based on a total weight of the second-first anode mixture layer.

16. The lithium secondary battery of claim 1,
wherein a content of the silicon-based active material included in the second-second anode mixture layer is 8 to 15 wt % based on a total weight of the second-second anode mixture layer.

17. The lithium secondary battery of claim 1,
wherein each of the first-second anode mixture layer, the second-first anode mixture layer and the second-second anode mixture layer further includes a conductive material.

18. The lithium secondary battery of claim 1,
wherein the electrode assembly satisfies the condition of the following Equation 1,
$$0.1 < A 1 / A 2 < 3.0 \qquad [ Equation 1 ]$$
where A1 is a total number of the first unit cells, and A2 is a total number of the second unit cells.

19. The lithium secondary battery of claim 1,
wherein the electrode assembly satisfies the condition of the following Equation 2,
$$0. 1 < B 1 / B 2 < 3.0 \qquad [ Equation 2 ]$$
where B1 is a total number of the first electrode group, and B2 is a total number of the second electrode group.

20. A secondary battery module including a lithium secondary battery according to claim 1.
